(19) United States
(12) Patent Application Publication
(10) Pub. No.: US 2007/0061187 A1
(43) Pub. Date: Mar. 15, 2007

(54) Modular system for determining return on investment from marketing communications

(76) Inventor: Marlene Laskowski-Bender, Austin, TX (US)

Correspondence Address: HAMILTON & TERRILE, LLP, P.O. BOX 203518, AUSTIN, TX, 78720, US

(21) Appl. No.: 11/222,578

(22) Filed: Sep. 9, 2005

(51) Int. Cl. G06F 17/30

(52) U.S. Cl. 705/10

(57) ABSTRACT

A modular system for determining return on investment from marketing communications which provides an efficient and timely process for measuring the effectiveness of marketing activities. The system is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities. Thus the modular system minimizes data integration and manipulation of metrics regarding marketing communications and expedites the generation of metrics regarding the effectiveness of marketing communications.

### BACKGROUND OF THE INVENTION

1. Field of the Invention

The present invention relates to the field of marketing communications and more particularly to determining return on investment for marketing communication expense.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue relating to information handling systems and to marketing in general relates to determining return on investment for marketing communication (marcom) expense. It is desirable for marketers and companies using marketers to have a precise measurement and proven return on investment to determine which types of marketing communication provide a desirable return on money spent for the marketing.

Advertising agencies and other types of marketers are being required to provide metrics that show real interactions by specific customers. This type of data is relatively easy to generate for some marketing mediums, such as the Internet. However, this same type of data can be somewhat difficult to obtain from other types of marketing mediums such as television and print.

Known methods for determining return on investment from marketing communications present a plurality of limitations. For example, know methods have a limited ability to effectively and efficiently measure a return on marketing communication expenditures. Known methods lack standardization and automation of the various information and range of marketing vehicles that is desired for determining a return on marketing communication expenditures. Known methods use extraneous processes for data gathering, integration and manipulation and these extraneous processes may be from disparate data sources (both internal data sources and external data sources.

Known methods thus present a challenge in not providing timely metrics regarding marketing communication effectiveness. Known methods have an inability to easily apply overlay and statistical applications to result sets of efficiency measures.

Accordingly, it is desirable to provide a system for determining return on investment from marketing communications. It is also desirable to provide such a system which provides timely metrics data regarding marketing communication effectiveness as well as an ability to easily integrate with business intelligence applications and apply overlay and statistical applications to gathered metrics data.

### SUMMARY OF THE INVENTION

In accordance with the present invention, a modular system for determining return on investment from marketing communications which provides an efficient and timely process for measuring the effectiveness of marketing activities. The system is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities. Thus the modular system minimizes data integration and manipulation of metrics regarding marketing communications and expedites the generation of metrics regarding the effectiveness of marketing communications.

In one embodiment, the invention relates to a method for analyzing marketing communication effectiveness. The method includes providing marketing communication with identification information; linking an order with the marketing communication via the marketing communication identification information; and, determining, via a marketing communication system, marketing communication effectiveness based upon the linking, the marketing communication system include modules for performing the linking and the determining.

In another embodiment, the invention relates to a method for analyzing marketing communication effectiveness which includes providing a marketing communication with identification information, linking an order with the marketing communication via the marketing communication identification information, and determining, via a marketing communication system, marketing communication effectiveness based upon the linking, the marketing communication system include modules for performing the linking and the determining.

In another embodiment, the invention relates to an apparatus for analyzing marketing communication effectiveness which includes providing a marketing communication with identification information, means for linking an order with the marketing communication via the marketing communication identification information, and determining, via a marketing communication system, marketing communication effectiveness based upon the linking, the marketing communication system include modules for performing the linking and the determining.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a marketing communications environment.

FIG. 2 shows a flow diagram of the operation of a marketing communication return on investment tool.

FIG. 3 shows a block diagram of a marketing communication return on investment system.

FIG. 4 shows a block diagram of the process flow of order attribution within the marcom ROI system.

FIG. 5 shows a flow diagram of inputs to and outputs from the marketing communication return on investment system.

FIG. 6 shows a block diagram of an example of the operation of the marcom return on investment system.

FIG. 7 shows a system block diagram of an information handling system for executing a marketing communication return on investment system.

FIG. 8 shows a block diagram of an alternate process flow of order attribution within the marcom ROI system.

### DETAILED DESCRIPTION

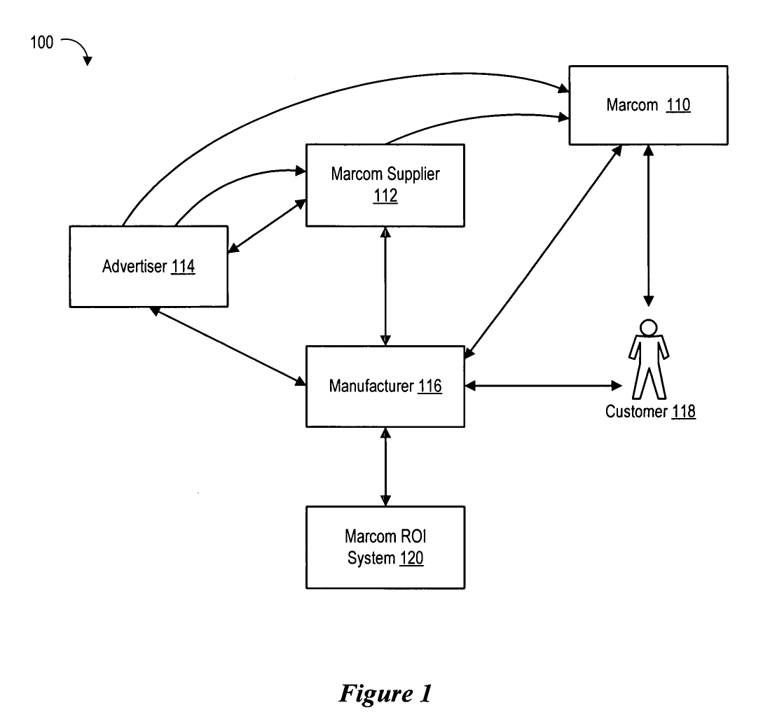

Referring to FIG. 1, a block diagram of a marketing communications environment 100 is shown. More specifically, a marketing communication environment 100 includes a marketing communication (marcom) 110, a marcom supplier 112, an advertiser 114 a manufacturer 116 and a customer 118. The marketing communication environment also includes a marketing communication return on investment (marcom ROI) system 120.

The marketing communication 110 may be any type of communication which presents marketing information to the customer 118 including television marcom, print marcom, direct mail marcom and internet based marcom.

In general, the advertiser 114 develops the marcom 110 to market a product produced by the manufacturer 116. The marcom is then distributed either directly by the advertiser 114 or via a marcom supplier 112. A customer 118 purchases a product based upon the marcom 110. In variations of the marketing communications environment 110, the manufacturer may develop the marcom 110 and either distribute the marcom 110 via the marcom supplier 112 or directly distribute the marcom 110. Additionally, various entities may be merged. So for example, the advertiser 114 may be part of the manufacturer 116, the marcom supplier 112 may be part of the advertiser 114 and any other combination of the entities. Additionally, the manufacturer is considered to be any supplier of a product or service for which marketing communications are used to communicate with a customer.

The manufacturer 116 can use the marcom ROI system 120 to determine the effectiveness of the marcom 110. The manufacturer 116 receives information from the marcom 110, the marcom supplier 112 and the advertiser 114 for use with the marcom ROI system 120.

The marcom ROI system 120 is a modular system for determining return on investment from marketing communications. The marcom ROI system 120 provides an efficient and timely process for measuring the effectiveness of marketing activities. The marcom ROI system 120 is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities. Thus, the modular system minimizes data integration and manipulation of metrics regarding marketing communications and expedites the generation of metrics regarding the effectiveness of marketing communications. By being modular, the marcom ROI system 120 is scalable by segment (i.e., a business unit or profit and loss center) and by marcom vehicle (i.e., a type of marcom). Such a modular system provides efficiency in terms of processing to link all of the various orders due to the volume of data. Such a scalable modular system can add or remove segments or vehicles without adversely affecting the operation of the marcom ROI system 120.

The marcom ROI system 120 resides within and executes on a data warehouse environment to provide the marcom ROI system 120 with enough processing power to receive and manipulate the amounts of marcom information provided by the various entities within the marketing communications environment as well as customer and order information for providing meaningful analysis of the information. The data warehouse is a substantially company wide data base and associated processing power that supports decision making within the organization. The data warehouse is structured to support a variety of analysis including elaborate queries on large amounts of data that require extensive searching. Data warehouse can support the storage of hundreds of gigabytes of data.

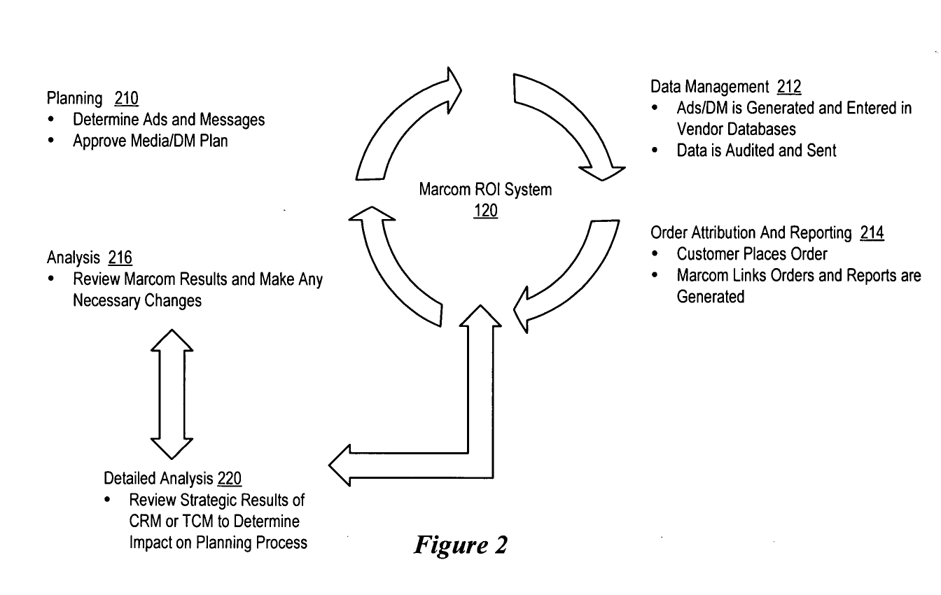

FIG. 2 shows a flow diagram of the operation of a marketing communication return on investment system 120. More specifically, operation of the marcom ROI system 120 includes a planning phase 210, a data management phase 212, an order attribution and reporting phase 214 and an analysis phase 216.

During the planning phase 210, the manufacturer 116 and one or more advertising agencies, including possibly a virtual agency (VA), or marketing suppliers determine the content of marketing communication as well as a plan for distributing the marketing communication and approve the communication and plan. During the data management phase 212 the marketing communication is generated and data about the marketing communication is entered into the database of the entity generating the marketing communication. Additionally, the data is audited and provided to the marcom ROI system 120. During the order attribution and reporting phase 214, data is generated when a customer 118 places an order. The marcom ROI system 120 links orders placed with particular marketing communications and generates reports based upon this linking. During the analysis phase 216, the manufacturer 116 reviews the results of the marketing communications and makes any necessary or desirable changes to the marketing communication. The planning phase 210 then starts again using the information developed during the analysis phase 216.

Additionally, the marcom ROI system 120 may be used to perform detailed analysis 220 in addition to the analysis that are performed during the analysis phase 216. For example, results from the marcom ROI analysis can be merged with results from customer response management (CRM) (which provides detailed customer information) or total cost of marcom (TCM) (which includes all customer related expenditures including customer care calls or technical support calls) are reviewed to determine whether there should be an impact on the planning process.

By providing a centralized marcom ROI system 120, marcom effectiveness can be evaluated across multiple marcom vehicles. Additionally the effect of featured products and promotions can be evaluated on an individual and collective basis.

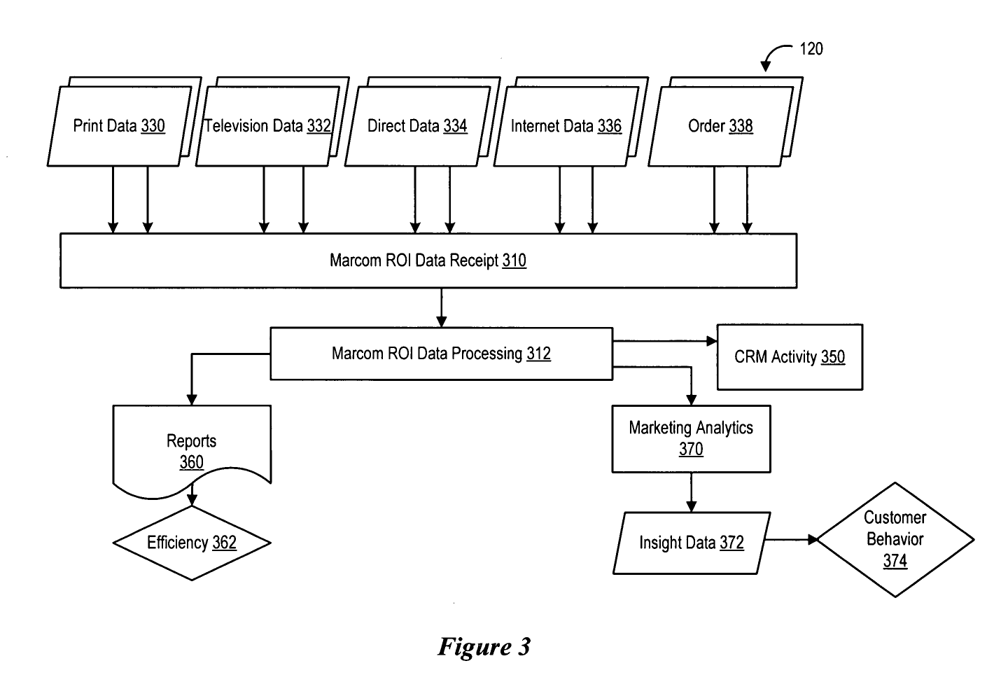

FIG. 3 shows a block diagram of a modular marketing communication return on investment system 120. More specifically, the marcom ROI system 120 includes a centralized marcom ROI data receipt module 310 and a marcom ROI data processing module 312. The centralized marcom ROI data receipt module 310 provides a central repository into which marcom data is received. The marcom ROI data receipt module 310 audits the received data to assure the quality of the data provided by the macrom sources.

The centralized marcom ROI data receipt module 310 provides the accumulated data to the marcom ROI data processing module 312. The marcom ROI data processing module 312 receives the data from the centralized marcom ROI data receipt module 310, links the received marcom data and populates results based upon the linked marcom data (e.g. magazine type print marcom or specific television marcom linked to a particular order number.)

The marcom ROI system 120 includes data from one or more of a plurality of marcom sources. For example, the data may include print marcom data 330, television marcom data 332, direct mail marcom data 334 and internet marcom data 336. The data is provided to the centralized marcom data receipt module 310. Additionally, the marcom ROI system 120 includes data from one or more order sources 338. Because the marcom ROI system 120 is modular, one or more of these data sources may be included within the marcom ROI system 120 based upon which types of marcom data are being analyzed. Additionally, more than one source may provide each type of data. So for example, the marcom ROI data receipt module 310 may receive data from two print data sources

The marcom ROI system 120 can interact with a CRM activity module 350. The CRM activity module 350 receives information from the marcom ROI data processing module 312 analyzes the processed marcom data along with CRM information.

The linked data results generated by the marcom ROI data processing module 312 may be provided to a plurality of sources via a data feed. The linked data results may be used to generate reports (including electronic reports and hard copy reports) via a reports module 360. The reports may be periodically generated such as reports that are generated weekly. The reports can be used to determine the efficiency 362 of the various marcom.

The linked data results 352 are also used to generate marketing analytics information via a marketing analytics module 370. The marketing analytics information includes customer insight data 372 such as first purchase marcom vehicle preference and second purchase marcom vehicle preference, effective acquisition marcom vehicle, or retention marcom vehicle. The insight data 372 provides insight into customer behavior 374.

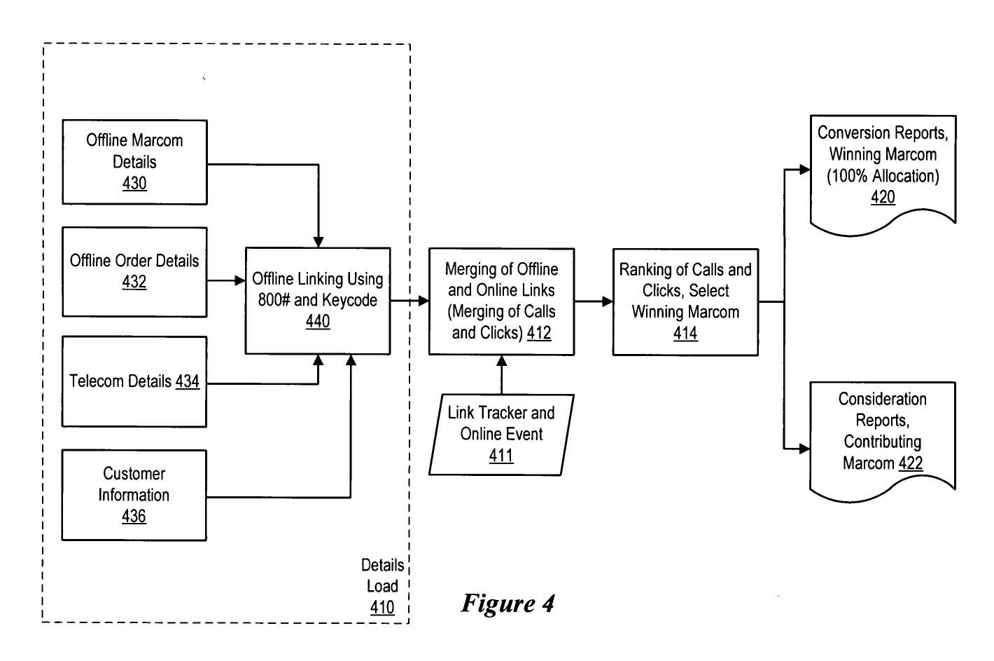

Referring to FIG. 4, a block diagram of the process flow of order attribution within the marcom ROI system 120 is shown. The process starts with an offline marcom details load process at step 410 as well as online event information details from, e.g., an online order attribution application, at step 411. The marcom system 120 merges offline details and the online link details at step 412.

During the marcom load, the marcom ROI system 120 determines which marcom to link with which orders using for example, the telephone numbers (e.g., various 800 numbers) used when interacting with the manufacturer or keycodes identified when interacting with the manufacturer.

Next the process identifies orders to link at step 412. During the identification step 412, the marcom ROI system 120 determines which orders to link for a predetermined amount of time. For example, the identification step may determine what new orders have been added since the last time that the system performed a link operation and whether there are any orders that need to be re-linked.

When determining the online event information details, the marcom system 120 may use a process such as an online order attribution application. The online order attribution application identifies orders that have been established and identifies any clicks that led up to the order. The linking may also include associating a key code with the marcom. Linking via a key code determines whether the order has a valid key code.

Next, at step 414, the marcom ROI system 120 generates a ranking of various marcom candidates (e.g., calls and clicks) to provide an indication of a winning marcom. The winning marcom is selected from a list of marcom candidates based upon a plurality of factors such as recency (a marcom vehicle that is closes to the order in terms of time and day) and business rules for each of the marcom candidates.

When ranking the various marcom candidates, the marcom ROI system 120 identifies the contacts leading up to the order (i.e., the contacts that factored into the consideration of the customer making a purchase). For example, with an internet type marcom, the contacts might include select clicks leading up to the order from online order attribution application (for online orders), select calls leading up to the order (for online and offline type orders). These marcom related calls or clicks that are identified as consideration (that were part of a customer's decision making process), and code links that are not selected as a winner are identified as consideration data (e.g., this information may be inserted into a consideration table).

The ranking generated at step 414 can be used to generate conversion reports 420 as well as consideration reports 422. The conversion reports 420 indicate a winning marcom when considering substantially all related marcom candidates (i.e., with 100% allocation). The consideration reports 422 takes into account contributing marcom. For example, a certain type of marcom might have resulted in a sale, while other types of marcom were presented to a particular customer and are assumed to have contributed to the sale.

During the details load step 410, the marcom system receives information from a variety of offline sources and links the information to the appropriate marcom. More specifically, the marcom system 120 receives offline marcom details 430, offline order details 432, telecom details 434 as well as customer information 436 and links this information using call in number information (such as 800 number information) and keycode information at step 440. Different marcom vehicles present different call in numbers or keycodes. Thus, based upon particular call in numbers and keycodes, a customer contact may be linked to a particular marcom vehicle.

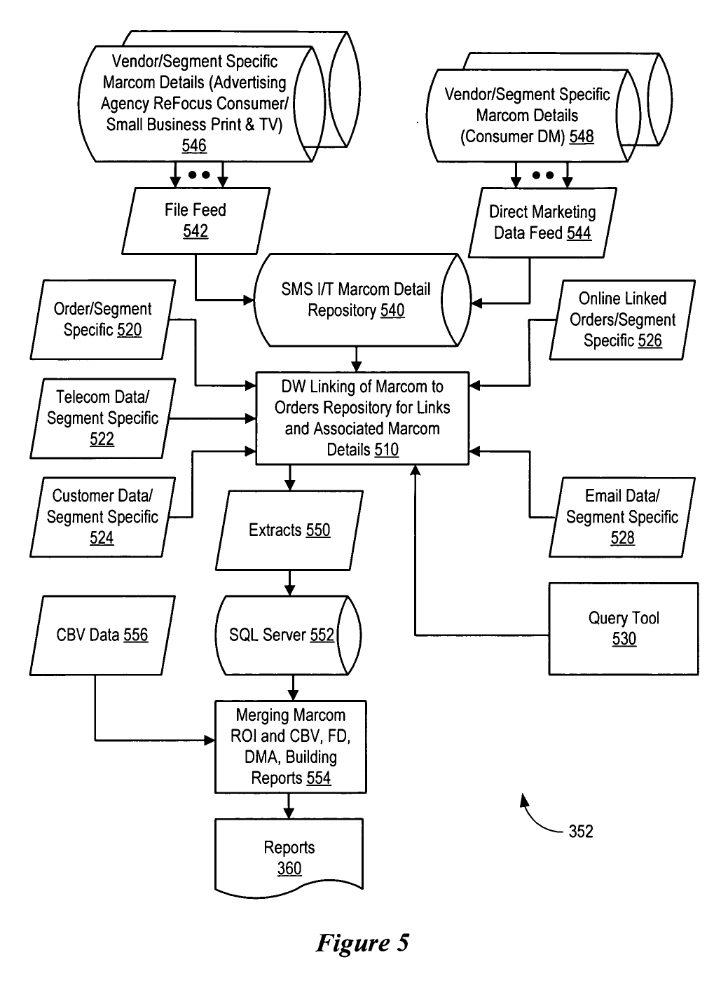

Referring to FIG. 5, a flow diagram of linked data module 352 of the marketing communication return on investment system 120 is shown. More specifically, the marcom ROI data processing module 312 includes a data warehouse (DW) linking repository module 510. The DW linking repository module 510 provides repository information relating to linking of marcom to orders for links and associated marcom details. The DW linking repository module 510 receives order data 520 that is segment specific, telecom data 522 that is segment specific, customer data 524 that is segment specific, online linked order data 526 that is segment specific and email data 528 that is segment specific.

The DW linking repository module 510 receives inputs from a links tool 530 such as a data warehouse database links tool. Thus the DW linking repository module 510 can be queried for results via the data warehouse. The data warehouse performs all of the linking functions and populates any related tables with the results of the links.

Based upon queries, the DW linking repository module 510 receives information from a sales marketing support information technology (SMS IT) marcom detail repository 540. The SMS IT marcom detail repository 540 also receives at least one agency file feed 542 and/or at least one direct marketing data feed 544. The agency file feed 542 receives vendor segment specific marcom details 546 such as print and television marcom details. The direct marketing data feed 544 receives vendor segment specific marcom details 548 such as direct marketing marcom details. The vendor segment specific marcom details 546 include agency consumer and small business print and TV information. The vendor segment specific marcom details 548 include consumer direct marketing information.

The marcom detail repository 540 stores information regarding key creative elements of the various marcom vehicles including pricing product offerings and promotions of each of the marcom vehicles, maintains all details of media planning and buying including unit sizes and types, circulations, etc.

The DW linking repository module 510 provides an output to an extracts module 550 including marcom details and linked results. The extracts module 550 provides an input to a structured links language (SQL) server 552. The SQL server 552 provides an input to a merge module 554. The merge module 554 also receives an input from a calls by vehicle (CBV) data module 556. The merge module 554 provides an output to the reports module 360. The merge module 554 merges marcom ROI information and calls by vehicle information, financial database (FD) information, direct marketing area information to build reports desired by various business units.

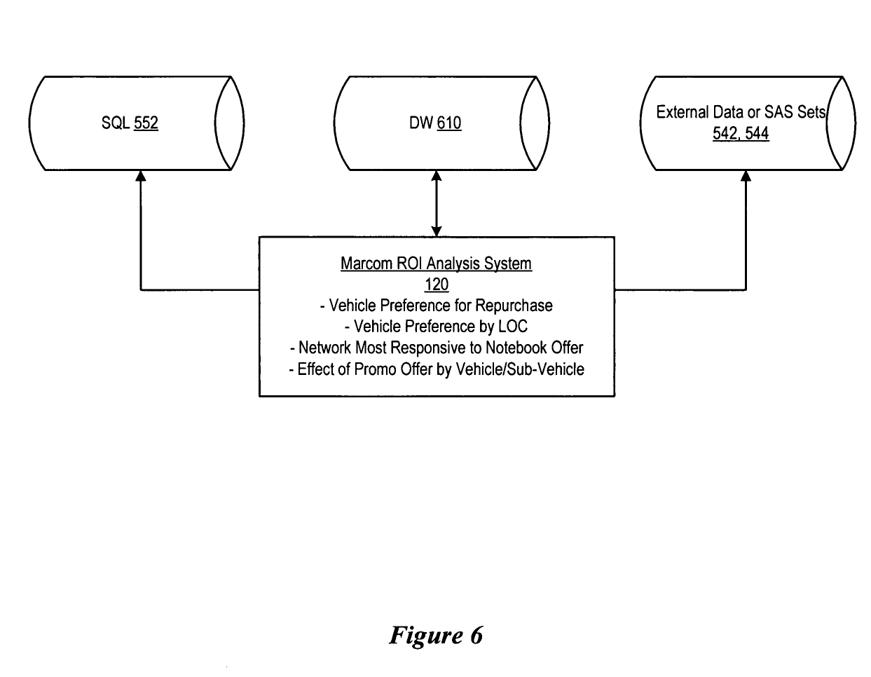

Referring to FIG. 6, a block diagram of an example of the operation of the marcom return on investment system 120 is shown. More specifically the marcom ROI system 120 resides on and interacts with the data warehouse 610. The marcom ROI system 120 links results and financials by business segment as well as a suggested winning marcom along with information regarding margin, revenue and units related to a particular marcom. The results provided by the marcom ROI system 120 include information by marcom vehicle and by segment relating to price, product and promotion. The marcom ROI system 120 provides to results to a database server 552 which can then analyze this information by line of business as well as by segment. The marcom ROI system 120 provides information to external data or statistical analysis software (SAS) sets regarding additional details about customer segment and customer demographics. This external data may be derived from data modelers or statisticians.

Using the marcom ROI system 120, a marcom vehicle preference for repurchase can be identified. The vehicle preference can be by line of business. E.g., the network that is most responsive to a notebook offer or the affect of a particular promotion by vehicle and sub vehicle can be determined by the marcom ROI system 120.

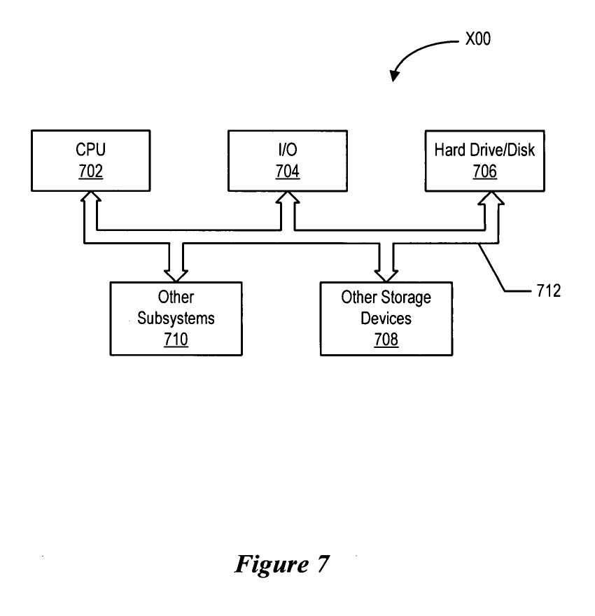

Referring briefly to FIG. 7, a system block diagram of an information handling system 700 is shown. The information handling system is an example of a product that is produced by the manufacturer. Additionally, the information handling system is an example of a system that executes the marcom ROI system 120. The information handling system 700 includes a processor 702, input/output (I/O) devices 704, such as a display, a keyboard, a mouse, and associated controllers, non-volatile memory 704 such as a hard disk and drive, and other storage devices 708, such as a floppy disk and drive and other memory devices, and various other subsystems 710, all interconnected via one or more buses 712. When the information handling system is executing the marcom ROI system 120, the marcom ROI system 120 is stored on the non-volatile memory 704 and executed by the processor 702.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example as well as large scale data bases or data warehouses. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, while certain types of marcom vehicles have been discussed, other types of vehicles are within the scope of the claims. Billboard marcom or radio marcom are two other examples of marcom that may be used within the marcom ROI system 120. Also, other types of segments are also within the scope of the claims. Any type of profit and loss center for a company could use the marcom ROI system 120 to determine the effectiveness of marcom for that profit and loss center.

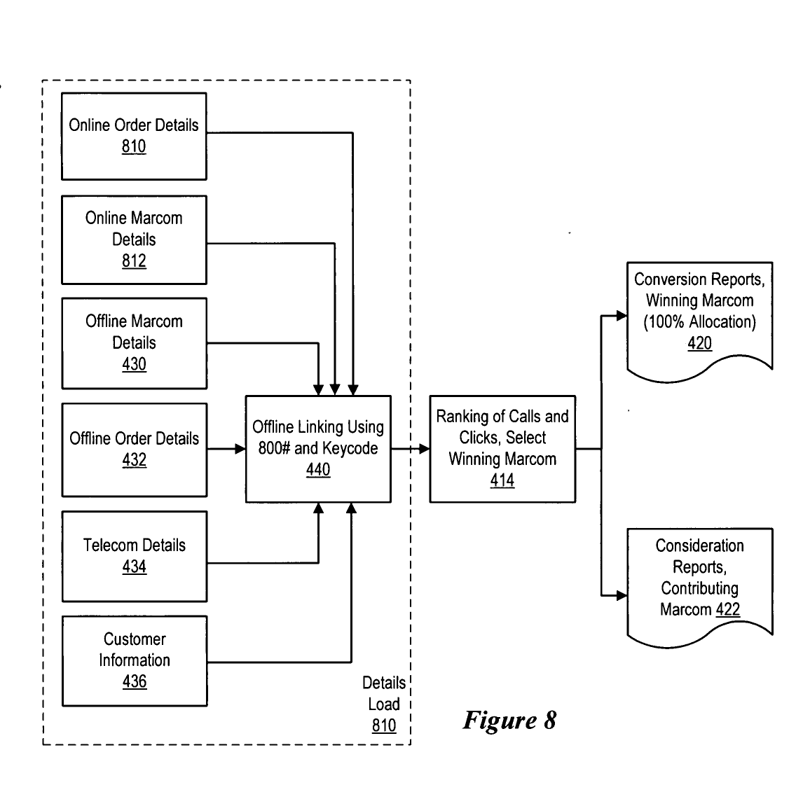

Also for example, referring to FIG. 8, a block diagram of an alternate process flow of order attribution within the marcom ROI system 120 is shown. Within the alternate process flow, online and offline information are both linked within the details load process at step 810. More specifically, the process starts with a marcom details load process at step 410. During step 810, the marcom system 120 merges online and offline details.

During the marcom load, the marcom ROI system 120 determines which marcom to link with which orders using for example, the telephone numbers (e.g., various 800 numbers) used when interacting with the manufacturer or keycodes identified when interacting with the manufacturer.

Next, at step 414, the marcom ROI system 120 generates a ranking of various marcom candidates (e.g., calls and clicks) to provide an indication of a winning marcom. The winning marcom is selected from a list of marcom candidates based upon a plurality of factors such as recency (a marcom vehicle that is closes to the order in terms of time and day) and business rules for each of the marcom candidates.

When ranking the various marcom candidates, the marcom ROI system 120 identifies the contacts leading up to the order (i.e., the contacts that factored into the consideration of the customer making a purchase). For example, with an internet type marcom, the contacts might include select clicks leading up to the order from an online order attribution application (for online orders), select calls leading up to the order (for online and offline type orders). These marcom related calls or clicks that are identified as consideration (that were part of a customer's decision making process), and code links that are not selected as a winner are identified as consideration data (e.g., this information may be inserted into a consideration table).

The ranking generated at step 414 can be used to generate conversion reports 420 as well as consideration reports 422. The conversion reports 420 indicate a winning marcom when considering substantially all related marcom candidates (i.e., with 100% allocation). The consideration reports 422 takes into account contributing marcom. For example, a certain type of marcom might have resulted in a sale, while other types of marcom were presented to a particular customer and are assumed to have contributed to the sale.

During the details load step 410, the marcom system receives information from a variety of online and offline sources and links the information to the appropriate marcom. More specifically, the marcom system 120 receives online order details 810, online marcom details 812, offline marcom details 430, offline order details 432, telecom details 434 as well as customer information 436 and links this information using call in number information (such as 800 number information) and keycode information at step 440 as well as link information. Different marcom vehicles present different call in numbers or keycodes. Thus, based upon particular call in numbers, keycodes and link information, a customer contact may be linked to a particular marcom vehicle.

Consequently, the invention is intended to be limited only by the spirit and scope of the appended claims, giving full cognizance to equivalents in all respects.

What is claim is:

1. A method for analyzing marketing communication effectiveness comprising:
providing a marketing communication with identification information;
linking an order with the marketing communication via the marketing communication identification information; and,
determining, via a marketing communication system, marketing communication effectiveness based upon the linking, the marketing communication system include modules for performing the linking and the determining.

2. The method of claim 1 wherein:
the marketing communication effectiveness relates to a return on investment for marketing communication expenditures.

3. The method of claim 1 wherein:
the marketing communication effectiveness relates to financial details for marketing communication expenditures.

4. The method of claim 3 wherein:
the financial details include information relating to units margin and revenue for marketing communication expenditures.

5. The method of claim 1 wherein:
the marketing communication system includes a print module, the print module determining the effectiveness of print marketing communications.

6. The method of claim 1 wherein:
the marketing communication system includes a television module, the television module determining the effectiveness of television marketing communications.

7. The method of claim 1 wherein:
the marketing communication system includes an internet module, the internet module determining the effectiveness of internet marketing communications.

8. The method of claim 1 wherein:
the marketing communication system includes a direct mail module, the direct mail module determining the effectiveness of direct mail marketing communications.

9. The method of claim 1 wherein:
the linking includes tracking information regarding creative elements of the marketing communication.

10. The method of claim 9 wherein:
the creative elements include at least one of pricing product offerings and promotions for the marketing communication, details of media planning of the marketing communication and buying information of the marketing communication.

11. An apparatus for analyzing marketing communication effectiveness comprising:
providing a marketing communication with identification information; means for linking an order with the marketing communication via the marketing communication identification information; and,
determining, via a marketing communication system, marketing communication effectiveness based upon the linking, the marketing communication system include modules for performing the linking and the determining.

12. The apparatus of claim 11 wherein:
the marketing communication effectiveness relates to a return on investment for marketing communication expenditures.

13. The apparatus of claim 11 wherein:
the marketing communication effectiveness relates to financial details for marketing communication expenditures.

14. The apparatus of claim 13 wherein:
the financial details include information relating to units margin and revenue for marketing communication expenditures.

15. The apparatus of claim 11 wherein:
the marketing communication system includes a print module, the print module determining the effectiveness of print marketing communications.

16. The apparatus of claim 11 wherein:
the marketing communication system includes a television module, the television module determining the effectiveness of television marketing communications.

17. The apparatus of claim 11 wherein:
the marketing communication system includes an internet module, the internet module determining the effectiveness of internet marketing communications.

18. The apparatus of claim 11 wherein:
the marketing communication system includes a direct mail module, the direct mail module determining the effectiveness of direct mail marketing communications.

19. The apparatus of claim 11 wherein:
the means for linking includes means for tracking information regarding creative elements of the marketing communication.

20. The method of claim 19 wherein:
the creative elements include at least one of pricing product offerings and promotions for the marketing communication, details of media planning of the marketing communication and buying information of the marketing communication.
